(19) United States
(12) Patent Application Publication
(10) Pub. No.: US 2011/0157462 A1
(43) Pub. Date: Jun. 30, 2011

(54) CAMERA MODULE

(75) Inventor: SSU-HAN HUANG, Tu-Cheng (TW)

(73) Assignee: HON HAI PRECISION INDUSTRY CO., LTD., Tu-Cheng (TW)

(21) Appl. No.: 12/749,719

(22) Filed: Mar. 30, 2010

(30) Foreign Application Priority Data
Dec. 25, 2009 (TW) 98145200

(51) Int. Cl. H04N 5/225

(52) U.S. Cl. 348/374; 348/E05.028

(57) ABSTRACT

A camera module includes a lens module, a printed circuit board (PCB), and a connection material. The lens module includes two pins. The PCB defines two conductive grooves. The lens module is disposed on the PCB. The pins are received in the conductive grooves and connected to the PCB through the connection material received within the conductive grooves.

### BACKGROUND

1. Technical Field

The present disclosure relates to a camera module.

2. Description of Related Art

Electronic camera modules include a lens module and a printed circuit board (PCB). The lens module includes a number of pads. The PCB forms a number of humps. The lens module is disposed on the PCB. The pads are aligned with the humps and connected to the humps using a connection material, such as solder or conductive adhesive. During the assembly process of the camera module, it is necessary to first melt the connection material to fully contact the pads and humps and then solidify the connection material to connect the pads and humps. However, it is difficult to control the position of the melted material and the melted material may move or spread out resulting in a poor connection.

Therefore, it is desirable to provide a camera module, which can overcome the above-mentioned limitations.

### BRIEF DESCRIPTION OF THE DRAWINGS

FIG. 1 is an isometric, exploded view of a camera module, according to one embodiment.

FIG. 2 is a cross-sectional, enlarged view of a portion II of FIG. 1.

FIG. 3 is a cross-sectional, enlarged view of a portion III of FIG. 1.

FIG. 4 is substantially similar to FIG. 2, but shows an electrical component and connection material.

### DETAILED DESCRIPTION

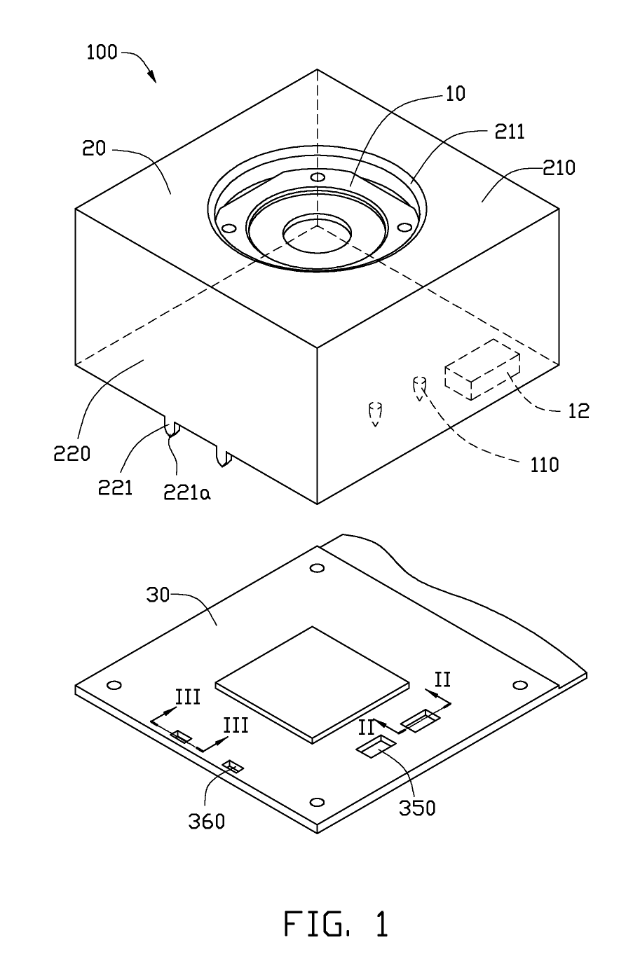

Referring to FIG. 1, a camera module 100, according to one embodiment, includes a lens module 10, a shield 20, and a printed circuit board (PCB) 30.

The lens module 10 includes an electronic element 12 and two first electrical pins 110. The electronic element 12 may be a voice coil motor (VCM) for adjusting the lens module 10 to focus. The first electrical pins 110 are configured for electrically connecting the electronic element 12 of the PCB 30. As such, the PCB 30 can supply power for and control the electronic element 12. In detail, the first electrical pins 110 protrude downwards (i.e., towards the image side of the lens module 10) from the bottom of the lens module 10 (i.e., the image-side end of the lens module 10).

The shield 20 is configured to protect the lens module 10 from interference by external electro-magnetic fields. The shield 20 includes a top plate 210 and a sidewall 220. The top plate 210 is configured for covering the top surface of the lens module 10 (i.e., the object-side end surface of the lens module 10). The sidewall 220 is configured for enclosing the side surface of the lens module 10 (i.e., the surface connecting the object side end and the image-side end of the lens module 10). The top plate 210 defines an aperture 211 to allow light rays to pass to the lens module 10. The shielding 20 also includes two second electrical pins 221 extending downwards (i.e., away from the top plate 210) from the bottom of the sidewall 220 (i.e., the end of the sidewall 220 far away from the top plate 210).

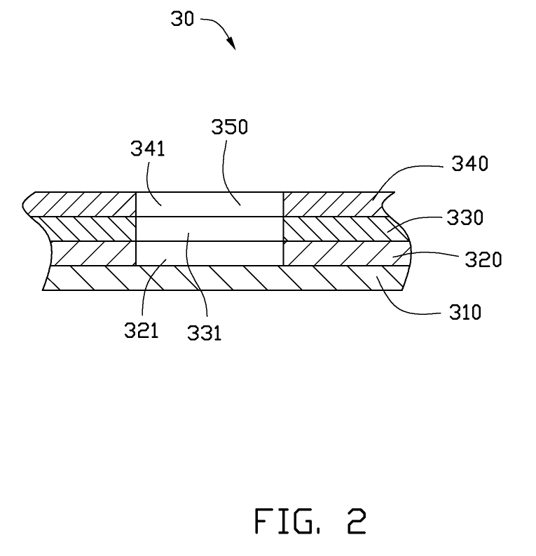

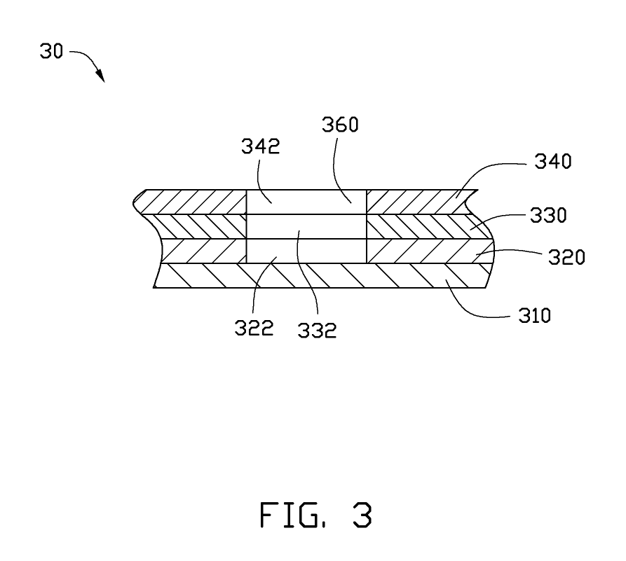

Also referring to FIGS. 2 and 3, the PCB 30 is a four-layer structure and includes a first layer 310, a second layer 320, a third layer 330, and a fourth layer 340 which are orderly stacked. The PCB 30 defines two first grooves 350 and two second conductive grooves 360 through the fourth layer 340, the third layer 330, and the second layer 320, corresponding to the first electrical pins 110 and the second electrical pins 221. That is, the first layer 310 is a continuous layer and the layers 320, 330, and 340 are holed layers. The depth of the grooves 350 and 360 is smaller than the length of the pins 110 and 221.

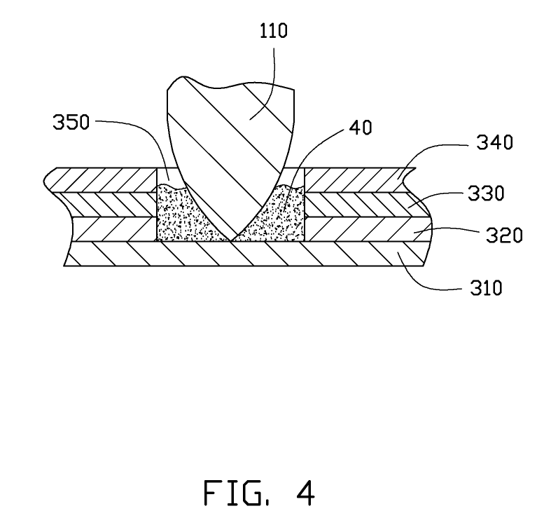

Also referring to FIG. 4, in assembly, the first layer 310, the second layers 320 defining a first through hole 321, the third layer 330 defining a second through hole 331, and the fourth layer 340 defining a third through hole 341 are separately formed and orderly stacked so that the though holes 321, 331, and 341 are aligned to each other to form the grooves 350 and 360. This forms the PCB 30.

Then, connection material 40, such as solder or conductive adhesive, is then added to the grooves 350 and 360. The shield 20 houses the lens module 10. The combined lens module 10 and shield 20 are disposed on the PCB 30. The pins 110 and 221 insert into the grooves 350 and 360, respectively. The connection material 40 is then melted and solidified to fixedly hold the pins 110 and 221 in the grooves 350 and 360, respectively. During the assembly process, the melted connection material is efficiently limited within the grooves 350 and 360.

It is noteworthy that the numbers of the pins 110 and 221, the grooves 350 and 360, the layers 310, 320, 330, and 340, and the layers run through by the grooves 350 and 360 are not limited to this embodiment, but can be set depending on requirements. The second conductive grooves 360 are grounded. As such, the shield 20 is connected to the ground to obtain the electro-magnetic shielding function. The pins 110 and 221 are longer than the depth of the grooves 350 and 360 for preventing the melted connection material from spreading over the bottom of the lens module 10.

While various exemplary and preferred embodiments have been described, it is to be understood that the disclosure is not limited thereto. To the contrary, various modifications and similar arrangements (as would be apparent to those skilled in the art), are also intended to be covered. Therefore, the scope of the appended claims should be accorded the broadest interpretation so as to encompass all such modifications and similar arrangements.

What is claimed is:

1. A camera module comprising:
a lens module comprising two pins;
a printed circuit board (PCB) defining two conductive grooves, the lens module being disposed on the PCB, the pins being received in the conductive grooves; and
a connection material received within the conductive grooves and electrically connecting the pins to the PCB.

2. The lens module of claim 1, wherein the lens module comprises an electronic element, the pins being configured for connecting the electronic element to the PCB.

3. The camera module of claim 2, wherein the electronic element comprises a voice coil motor (VCM).

4. The camera module of claim 1, wherein the PCB comprises a continuous layer and a plurality of holed layers stacked orderly, the first conductive grooves running through the holed layers.

5. The camera module of claim 4, wherein the continuous layer and the holed layer are separately formed.

6. The camera module of claim 4, wherein each holed layer defines two through holes, the through holes being aligned with each other to form the conductive grooves.

7. The cameral module of claim 1, wherein the connection material is selected from the group consisting of solder and conductive adhesive.

8. The camera module of claim 1, further comprising a shield for shielding the lens module form interference by external electro-magnetic fields.

9. The camera module of claim 8, wherein the PCB defines two grounded grooves, the shield comprising two shield pins received in the grounded grooves and connected to the PCB through the connection material.
